(19) United States
(12) Patent Application Publication
(10) Pub. No.: US 2009/0016945 A1
(43) Pub. Date: Jan. 15, 2009

(54) Use of tin phosphates in thermoplastic materials that can be laser-inscribed

(76) Inventors: Joachim Markmann, Dorsheim (DE); Ruediger Wissemborski, Gau-Algesheim (DE)

Correspondence Address: MICHAEL L. DUNN, SIMPSON & SIMPSON, PLLC, 5555 MAIN STREET, WILLIAMSVILLE, NY, 14221, US

(21) Appl. No.: 11/665,198

(22) PCT Filed: Oct. 14, 2005
(86) PCT No.: PCT/EP05/55283

§ 371 Date: Feb. 8, 2008

(30) Foreign Application Priority Data
Oct. 15, 2004 (DE) 10 2004 050 481.4

(51) Int. Cl. C01B 25/37

(52) U.S. Cl. 423/311; 423/305

(57) ABSTRACT

A tin phosphate pigment compound with a residual moisture content of a maximum 1% by weight. The compound preferably is a tin orthophosphate with a mean grain fineness of 8 to 20 μm (d₅₀), preferably below 10 μm and most preferably below 5 μm and a lightness corresponding to an L-value of 92 to 110.6. A tin orthophosphate of claim 5 with a mean grain fineness of below 10 μm. The invention further includes a laser writable/markable thermoplastic material comprising a tin phosphate compound as described above.

### BACKGROUND OF THE INVENTION

The invention concerns the writability or markability of plastic articles with laser light.

Marking and writing on plastic articles has long been known, and it has also already been known for many years that most plastic materials do not absorb laser light and therefore cannot be written upon as such. For that reason, finely divided pigments are added to the plastic materials, the pigments absorbing the laser light and changing in color under the influence of the laser light. In that respect the notion of color change is viewed independently of the mechanism. In addition here the term “color change” includes the fact that a different color from the original one is produced or that the same or a similar color is formed, but with a different level of lightness. Color change can also signify here that a solution was initially colorless and acquired a given color by virtue of the laser light or that a color change occurs in the plastic material.

The problem which prevails in that respect is that a laser inscription which is clearly legible requires a strong color contrast between the two states prior to irradiation with laser light on the one hand and after such irradiation on the other hand, as similar color shades in both states entail considerable problems when reading the inscribed plastic materials.

It is also already known to use metal salts for that purpose, such as for example copper hydroxide phosphate, but that compound still does not always satisfy the requirements of industry, and for that reason the search still goes on for compounds which, by increasing the color contrast of the states of given or practically all plastic materials prior to and after laser light irradiation, facilitate reading thereof.

### BRIEF DESCRIPTION OF THE INVENTION

Surprisingly it has now been found that the above problems can be eliminated or reduced by using at least one tin phosphate salt, in particular by using tri-tin phosphate, as a pigment for thermoplastic materials, insofar as the laser writability thereof is abruptly improved. Besides tri-tin phosphate it is also possible to use pyrophosphate and tin salts of the further condensed polyphosphoric acids individually or mixed with each other. It will be appreciated that usual additives for improving certain properties can also be added to the phosphates or may be included therein as impurities originating from manufacture.

In particular, the invention includes a tin phosphate pigment compound with a residual moisture content of a maximum 1% by weight. The compound preferably is a tin orthophosphate with a mean grain fineness of 8 to 20 μm (d₅₀), preferably below 10 μm and most preferably below 5 μm and a lightness corresponding to an L-value of 92 to 110.6. A tin orthophosphate of claim 5 with a mean grain fineness of below 10 μm.

The invention further includes a laser writable/markable thermoplastic material comprising a tin phosphate compound as described above.

### DETAILED DESCRIPTION OF THE INVENTION

The pigment for achieving and improving laser writability must be distributed as uniformly as possible in the plastic article which is to be made writable, overall or in certain regions, such as the surface regions. For that purpose the pigment should be particulate and finely divided and should involve a mean particle size (d₅₀) of below 20 μm, preferably below 5 μm. The mean grain fineness has a substantial influence on the properties and thus the suitability for use as a pigment for laser writability.

The tin compounds, in particular tri-tin phosphate, have a very high bulk density. The low mean grain fineness has a substantial influence on laser writability. A higher level of grain fineness results in increasing the amount of energy required while an excessively low level of grain fineness results in unwanted foaming in the upper regions of the plastic material.

The lightness value which is referred to as the L-value is between 92 and 110 so that this material can be identified as almost white, which affords substantial advantages when being incorporated into light plastic materials. The described product can be very quickly dried down to a low water content. Residual moisture levels of below 0.5% by weight are determined with the Karl Fischer water determination method.

The tri-tin phosphate according to the invention has a mean grain fineness (d₅₀) of 8 to 20 μm (d₅₀), preferably below 10 μm, preferably below 5 μm, in particular below 1 μm, lightness values (L-value) of 92 to 110 and residual moisture levels of below 1% by weight, preferably at 1 to 5 μm, preferably over 0.1 μm. Preferably the levels of grain fineness are below 10 μm (d₅₀), the L-values are preferably in the range of 94 to 98 and the residual moisture levels are preferably below 0.5% by weight. The color contrast between a state of not being irradiated with laser light and a state of being irradiated with laser light is considerable.

The production of the tin phosphates is known from “Gmelin, Handbuch der Anorganischen Chemie: Zinn, part C, 2nd to 8th edition—Springer-Verlag, Berlin, 1975, pages 245-259.

The tri-tin phosphate is introduced into the plastic matrix in an amount of 0.1 to 1.0% by weight, preferably around 0.5% by weight. In addition to that tin orthophosphate it is also possible to incorporate other pigments such as for example copper phosphate or other substances for achieving specific properties.

### EXAMPLES

### Example 1

The tin orthophosphate produced in accordance with the following paragraph is incorporated in accordance with the invention into a polyamide matrix in an amount of 0.5% by weight, the molding material is processed to constitute an injection molded plate and then provided by means of an Nd-YAG laser at a wavelength of 1046 nm with a marking which has a K-value of over 4. The tin orthophosphate used in that respect is produced as follows:

A trisodiumorthophosphate is dissolved in water and reacted at ambient temperature with an aliquot portion of tin chloride. A 30 minutes post-reaction time is waited. Suction removal is then effected and the resulting deposit of tertiary tin phosphate washed with water to give freedom from chloride. The procedure then involves careful drying over P₂O₅ and crushing.

The tertiary tin phosphate used in that case is alternatively produced as follows:

Tin sulfate is dissolved in water and mixed with an aliquot portion of phosphoric acid so that tertiary tin phosphate is produced. A pH-value of 9 is then set with sodium hydroxide and the tri-tin phosphate produced is separated and washed. The procedure then involves careful drying over P₂O₅ and crushing.

### Example 2

The addition of 0.5% by weight of tin phosphate to a polyamide matrix and the additional addition of an iron phosphite in an amount of 0.5% by weight and subsequent processing of the plastic material to constitute plates and inscription with an Nd-YAG laser at a wavelength of 1064 or 532 nm gives an inscription with a K-value of more than 3.5.

What is claimed is:

1-3. (canceled)

4. A tin phosphate pigment compound with a residual moisture content of a maximum 1% by weight.

5. A tin orthophosphate of claim 4 with a mean grain fineness of 8 to 20 μm (d₅₀) and a lightness corresponding to an L-value of 92 to 110.

6. A tin orthophosphate of claim 5 with a mean grain fineness of below 10 μm.

7. A tin orthophosphate of claim 6 with a mean grain fineness of below 5 μm.

8. A laser writable/markable thermoplastic material comprising a tin phosphate compound with a residual moisture content of a maximum 1% by weight as a pigment.

9. The laser writable/markable thermoplastic material of claim 8 where the tin compound has with a mean grain fineness of 8 to 20 μm (d₅₀) and a lightness corresponding to an L-value of 92 to 110.

10. The laser writable/markable thermoplastic material of claim 9 where the tin compound has with a mean grain fineness of below 10 μm.

11. The laser writable/markable thermoplastic material of claim 9 where the tin compound has with a mean grain fineness of below 5 μm.
